(19) United States
(12) Patent Application Publication
(10) Pub. No.: US 2026/0304034 A1
(43) Pub. Date: Oct. 1, 2026

(54) DEVICE ORIENTATION BASED ON SOUND

(71) Applicant: Motorola Mobility LLC, Chicago, IL (US)

(72) Inventor: Giles Tucker Davis, Downers Grove, IL (US)

(73) Assignee: Motorola Mobility LLC, Chicago, IL (US)

(21) Appl. No.: 19/094,174

(22) Filed: Mar. 28, 2025

(51) Int. Cl. H04R 1/40

(52) U.S. Cl. CPC H04R 1/406

(57) ABSTRACT

Techniques for device orientation based on sound are described. In implementations, a computing device detects speech input of a user with a plurality of microphone pairs of a microphone array that are non-coplanar and each oriented about one of three B-format axes of a device orientation. The device determines a sound direction towards a mouth of the user relative to the device orientation based on the speech input. The device receives additional sounds of the user (e.g., finger snaps) generated at different horizontal positions (e.g., right, left, front, back) relative to a horizontal body plane. The device establishes a device position worn on a user body based on the sound direction and the horizontal body plane. Then, the device modifies audio input and output settings based on a device position where the device is worn on a user body, the sound direction, and the horizontal body plane.

### BACKGROUND

Conventional spatial audio, beamforming, and directional sensing systems typically utilize four microphones arranged as three orthogonal pairs, calibrated with orientation sensors like accelerometers and gyroscopes to align along different axes for sound direction identification. These systems perform 3D sound localization, enhance audio processing, and enable acoustic sensing by analyzing differences between microphone signals. However, the performance of conventional systems relies on precise calibration achieved through orientation sensors, which introduces additional cost and complexity.

### BRIEF DESCRIPTION OF THE DRAWINGS

Aspects of device orientation based on sound are described with reference to the following Figures. The same numbers may be used throughout to reference similar features and components that are shown in the Figures. Further, identical numbers followed by different letters reference different instances of features and components described herein.

FIG. 1 illustrates a diagram of an environment showing a wearable device with audio processing components, in accordance with one or more implementations of device orientation based on sound.

FIG. 2 depicts a block diagram of a system with audio processing components, in accordance with one or more implementations of device orientation based on sound.

FIGS. 3a through 3e illustrate conceptual diagrams of beam pattern modifications and body format relative device orientation based on sound, in accordance with one or more implementations.

FIG. 4 illustrates a flow chart depicting an example process for device orientation based on sound in accordance with one or more implementations.

FIG. 5 illustrates a flow chart depicting an example process for device orientation based on sound in accordance with one or more implementations.

FIG. 6 illustrates a flow chart depicting an example process for device orientation based on sound in accordance with one or more implementations.

FIG. 7 illustrates multiple perspective views of beam patterns demonstrating beam pattern configuration changes, in accordance with one or more implementations of device orientation based on sound.

FIG. 8 illustrates various components of an example device in which aspects of device orientation based on sound can be implemented in accordance with one or more implementations.

### DETAILED DESCRIPTION

Techniques related to device orientation based on sound are described. These techniques repurpose existing microphone arrays configured to capture speech inputs as part of a voice-enabled user interface to determine an alignment between a device orientation and a body of a user. Performance of conventional approaches to spatial audio, beamforming, and directional sensing systems depends on precise system calibration using orientation sensors (e.g., accelerometers and gyroscopes) to align microphone arrays along B-format (e.g., right-left, front-back, and up-down body worn) device axes for identifying directions of sounds. By avoiding orientation sensor driven calibrations, the described techniques reduce device complexity and manufacturing costs, while maintaining or improving functionality, particularly for devices that can be positioned in various orientations, e.g., on a user body, on clothing, and held in hand.

In an implementation, a computing device includes a microphone array with three directional elements and one omnidirectional element. In examples, this can be achieved with four omnidirectional microphones including multiple pairs of microphones oriented about different axes that define a device orientation (e.g., right-left, front-back, and up-down B-format audio encoding defined axes, X, Y, and Z cartesian axes, and so forth). For example, the microphone array includes four microphones arranged to form the three directional elements and the one omnidirectional element that are oriented about the three different B format axes. When speech input is detected, the computing device analyzes sound captured from the microphones (e.g., by analyzing time and intensity differences between microphone signals captured by the different microphone elements) to determine a voice direction towards a mouth of the user relative to the device orientation. The computing device then modifies a beam pattern of the microphone array based on the voice direction to optimize signal-to-noise ratio for the user's voice. The device incorporates additional sounds generated by the user at different lateral positions relative to a horizontal body plane. For example, the computing device establishes the right-left and front-back device axes by detecting sequential clicking or snapping sounds at different XY co-planar positions, first to the left (or right) and then to the front of the user.

The techniques discussed herein support B-format audio encoding of three-dimensional sound fields using four channels: W (omnidirectional pressure), X (front-back), Y (left-right), and Z (up-down). The B-format aligns with the four microphone element configuration in the computing device, enabling flexible manipulation of the sound field, including rotation. By capturing speech input and other sounds in an audio format or frame of reference analogous to B-format, the computing device can perform spatial audio processing, beamforming, and sound source localization with enhanced precision and adaptability. The sequential snapping sounds allow the device to establish orientation relative to a user's body, enabling automatic calibration and adjustment of audio input and output settings. This capability enhances the computing device's ability to adapt audio capture and processing based on its orientation relative to the user, without relying on additional sensors. By combining the voice direction and the established B-format orientation, the device can infer whether it is worn on the head or body and automatically calibrate and adjust audio input and output settings accordingly.

Conventional approaches for determining device orientation often rely on complex accelerometers or gyroscopes, which include additional components and may not accurately capture device positioning in some handheld or wearing configurations. In contrast, the techniques discussed herein enable dynamic adaptation while reducing hardware complexity. The flexibility of these techniques enhances the reliability and functionality of audio devices, including wearable devices, in diverse usage contexts, improving spatial audio performance across various scenarios. For wearable devices, the techniques enable accurate audio capture and processing across various wearing scenarios, accommodating different users and relative to positioning of a device audio system, without introducing cost and complexity of additional sensors. By modifying beam patterns based on a B-format aligned device orientation established from sequential snapping sounds, and optimizing for voice direction, the techniques can improve capture quality or audio output from the wearable devices. In some implementations, devices are further operable to authenticate the user based on the speech input prior to modifying the beam pattern. The modified beam pattern can be stored by the device to be automatically applied for subsequent speech inputs from the user or audio inputs from the environment surrounding the user, simultaneously enhancing audio quality, and promoting security using an existing microphone array independent from additional sensors.

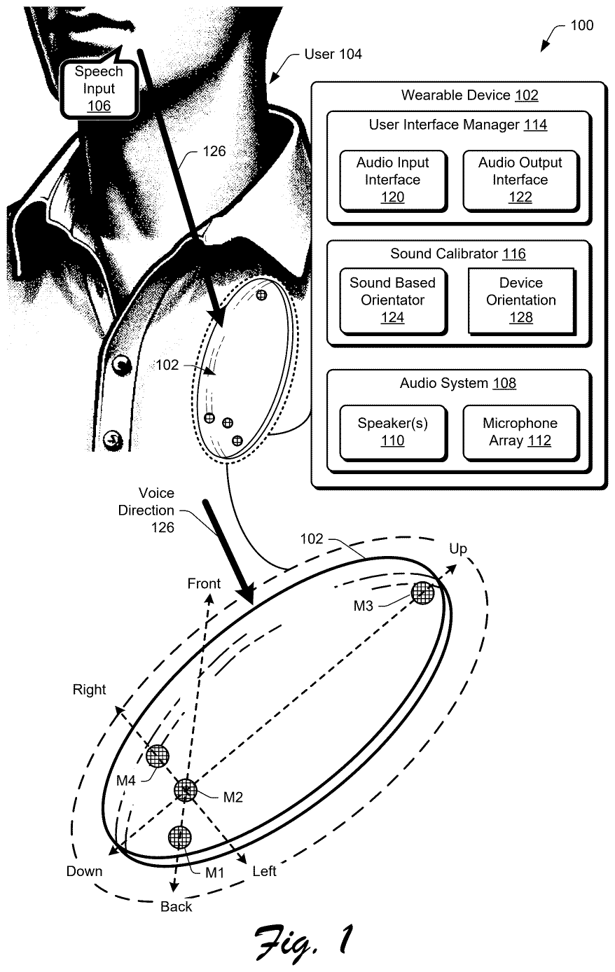

FIG. 1 illustrates a diagram of an environment 100 showing a wearable device 102 with audio processing components, in accordance with implementations of device orientation based on sound. The wearable device 102 is depicted being worn by a user 104, e.g., attached to a chest area of a shirt. An exploded view of the environment 100 is depicted at the bottom of FIG. 1, showing the wearable device 102 in greater detail, including a device orientation defined by three B-format axes right-left, front-back, and up-down. A conceptual view of the wearable device 102 is also depicted on the right side of FIG. 1 illustrating a configuration operable to implement techniques related to device orientation based on sound.

The wearable device 102 represents a device capable of audio capture and output, such as a wearable artificial intelligence (AI) assistant, smart pin, clip-on audio device, computerized watch, computerized ring, smart eyeglasses, smart headphones, fitness trackers, computerized headset, immersive computerized goggles, and the like. The described techniques are not limited to wearable devices. In variations, the wearable device 102 may be a non-wearable device, including a computing device such as a desktop or laptop computer, or a mobile device, such as a smartphone or tablet. The wearable device 102 is one example of a computing device that can include various components, such as a processor system, memory, as well as any number and combination of different components configured to perform the described techniques, and as further described with reference to the example device 800 shown in FIG. 8. For example, the wearable device 102 may include sensors, cameras, displays, and wireless communication capabilities to enable a range of interactive functions.

The wearable device 102 is depicted being worn by a user 104, demonstrating its capability to determine device orientation based on sound, which is illustrated as speech input 106 emanating from a user mouth. The wearable device 102 is configured to receive the speech input 106 by detecting sound signals from the user 104 using an audio system 108 that includes one or more speakers 110 and a microphone array 112, which together implement a voice-enabled user interface. For example, a user interface manager 114 executes on the wearable device 102 to implement functions based on detected speech input 106, such as when the user 104 is speaking voice commands for controlling the wearable device 102 for playing music from the speakers 110.

The speakers 110 are configured to output audio for the wearable device 102. They may include various types of audio output components such as traditional cone speakers, piezoelectric speakers, or bone conduction transducers. The speakers 110 can be arranged in different configurations to provide stereo or surround sound effects. For example, there may be left and right speakers positioned on opposite sides of the device 102, or multiple speakers distributed around the perimeter (e.g., housing) of the device 102. The speakers 110 work in conjunction with the audio system 108 to deliver high-quality sound to the user 104, whether for voice feedback, music playback, or other audio outputs. The speakers 110 may include various types such as balanced armature drivers found in high-end in-ear monitors or dynamic drivers common in consumer headphones. They may be arranged for stereo or surround sound, similar to the spatial audio capabilities of advanced wireless earbuds.

The microphone array 112 includes three directional elements and one omnidirectional element. In examples, the microphone array 112 has four omnidirectional microphones including multiple microphone pairs oriented about different axes of the device orientation, potentially using micro-electromechanical systems (MEMS) microphones. In examples, this includes four microphones arranged to form the three directional elements and the one omnidirectional element of the microphone array 112, which as depicted in FIG. 1 are labeled M1, M2, M3, and M4. The microphones of the microphone array 112 are positioned about the three different B format axes. These B format axes define a device orientation, enabling the device to adjust settings to improve audio input capture from various directions and determine sound sources in three-dimensional space. For example, M3 and M2 define the up-down-axis, M4 and M2 define the right-left-axis, and M2 and M1 define the front-back-axis. The B-format aligned microphones of the microphone array 112 detect sound, allowing the audio system to enable time and intensity difference analysis of microphone signals to identify sound direction along each axis.

The user interface manager 114 and sound calibrator 116 are components of the wearable device 102 that collaborate to process audio inputs and determine device orientation. Each component communicates with the audio system 108 to operate and configure the speakers 110 and the microphone array 112 for capturing and outputting sound. The user interface manager 114 may be implemented using machine learning frameworks or neural networks to implement functionality and facilitate user interactions. The user interface manager 114 manages audio input and output interactions using one or more subcomponents, depicted in FIG. 1 as the audio input interface 120 and the audio output interface 122. The audio input interface 120 processes speech input 106 captured by the microphone array 112 and analyzes differences in arrival time and sound intensity at each microphone of the microphone array 112 to calculate the direction of the speech input 106. By combining data from the different elements of the microphone array 112 that are measuring sound intensity along the B-format axes of the wearable device 102, the user interface manager 114 can invoke functions for computing the 3D position or direction of a source of sound. The audio output interface 122 manages the speakers 110, which can include various types of audio output components such as traditional cone speakers, piezoelectric speakers, or bone conduction transducers. These speakers can be arranged in different configurations to provide stereo or surround sound effects, working in conjunction with the audio system 108 to deliver high-quality sound to the user 104 for voice feedback, music playback, or other audio outputs. By combining data from the different elements of the microphone array 112, the user interface manager 114 can invoke functions for spatial audio and immersive user experiences.

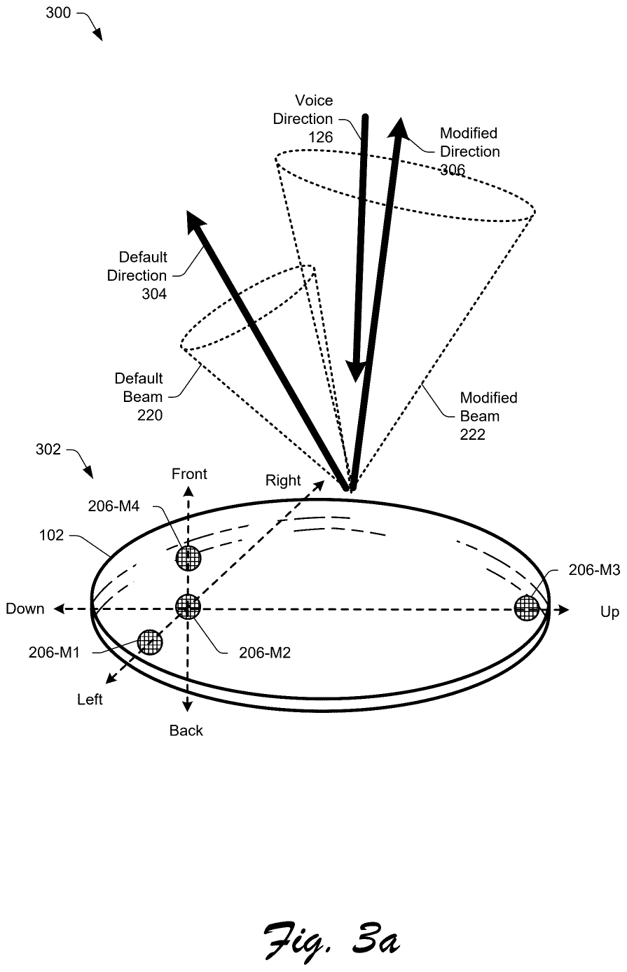

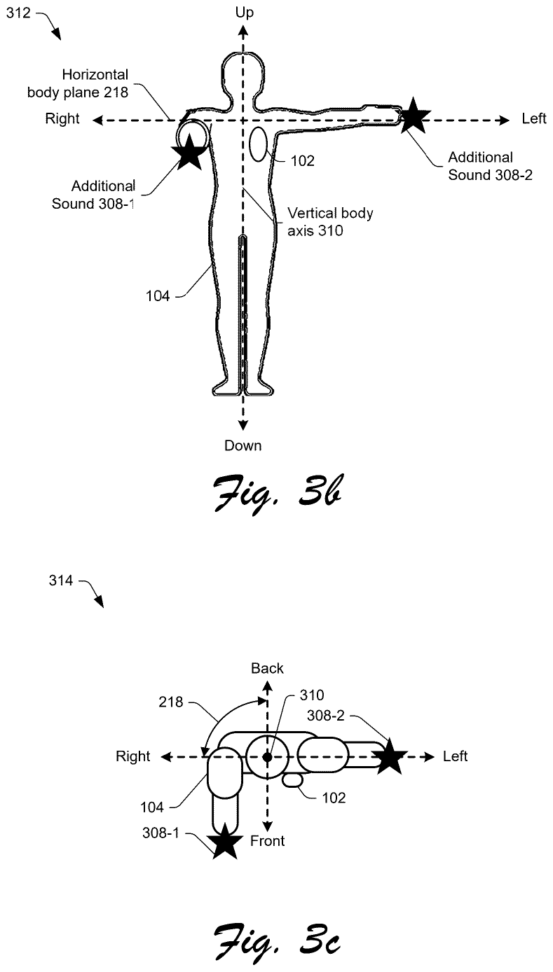

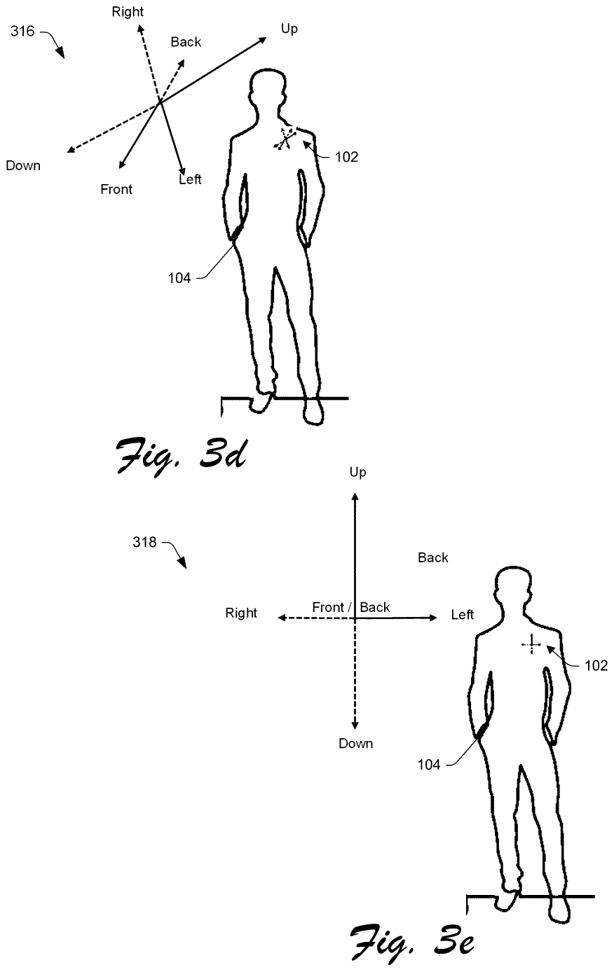

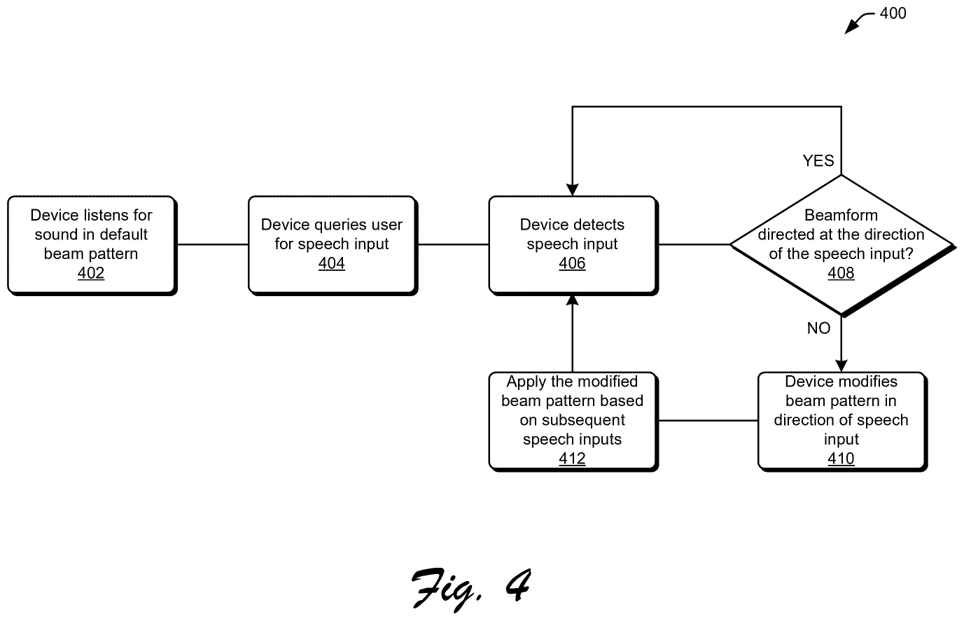

The sound calibrator 116 determines and maintains an accurate device orientation 128. The sound based orientator 124 of the sound calibrator 116 establishes the device orientation 128 without using conventional inertial measurement units, accelerometers, or gyroscopes. The sound based orientator 124 first utilizes the voice direction 126 obtained based on information received by the audio input interface 120 to optimize signal-to-noise ratio for the user's voice, which may be to one side or the other of the device rather than aligned with any particular axis. For establishing the B-format axes relative to the user's body, the sound based orientator 124 analyzes time differences and/or intensity differences of sequential sounds in the horizontal plane. For example, as depicted in FIGS. 3a through 3e and described throughout below, this involves requesting the user 104 to generate specific sounds, such as finger snaps, at different positions around their body in sequence. First, the user generates a snap to the left (or right), which defines the left-right axis. Then, the user generates a snap to the front, which defines the front-back axis. The audio input interface 120 captures these sequential sounds, and the sound based orientator 124 examines the time differences and/or intensity differences to establish the horizontal body plane. For example, the user 104 stands with their arms extended, such as one arm raised at shoulder height fully extended to the left or right side of the user 104, and then the other arm raised at shoulder height fully extended in front of the user 104. Once the left-right and front-back axes are established, the up-down axis is determined using the left-hand thumb rule: pointing fingers of the left hand to the left and curling them toward the front, with the thumb pointing up. If the snaps were directed to be to the right and then front, the right-hand thumb rule would be used instead. After establishing the B-format axes, the sound calibrator 116 can compare the voice direction 126 to the established up direction to determine whether the device is worn on the head (voice direction pointing down) or on the body (voice direction pointing up). If recalibration is initiated (e.g., based on detecting device movement, detachment, reattachment, reset, etc.) the audio output interface 122 can prompt the user 104 for new audio inputs by communicating with the user 104 through the speakers 110.

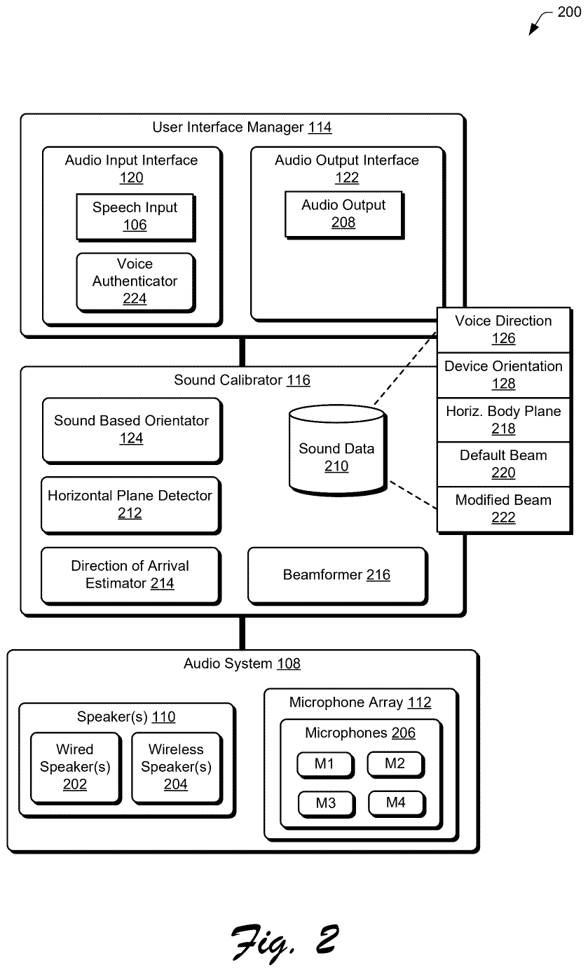

The device orientation 128 is generated through collaboration between the audio input interface 120, the audio output interface 122, and the sound based orientator 124, with an initial focus on identifying the voice direction 126 for optimizing audio capture. The audio input interface 120 provides the initial voice direction data (e.g., sound signal data captured by the microphone array 112). The sound based orientator 124 then establishes the B-format axes through sequential finger snaps or similar sounds at different positions, independent of the voice direction, to create a three-dimensional coordinate system aligned with the user's body. This approach eliminates reliance on conventional calibration approaches that use accelerometers to detect tilt angles and adjust audio settings (e.g., microphone signal interpretation). The sound calibrator 116 includes a beamformer component described in FIG. 2, which uses the device orientation 128 information to focus the device audio capture in specific directions, for example, in the voice direction 126, in the forward direction along the front axes in front of the user 104. The beamformer component within the sound calibrator 116 focuses audio pickup directionally, potentially using techniques similar to those in professional-grade virtual reality microphones. This improves audio capture quality by steering the beam pattern towards the user's mouth. The sound based orientator 124 causes the sound calibrator 116 to communicate with the microphone array 112 to implement beam steering of the beam pattern projected from the microphone array 112 toward closer alignment with the source of the speech input (e.g., the user's mouth) to improve audio capture quality.

The device 102 can adapt to changes in its position relative to the user 104. If the sound based orientator 124 detects a possible positional change (e.g., based on being detached, reattached, reset, etc.), the device 102 can use the audio output interface 122 and speakers 110 to request new speech input from the user 104 for recalibration, ensuring accurate orientation determination in various wearing scenarios. This dynamic adaptation replaces the conventional approach of using an accelerometer to detect device repositioning and adjust microphone signal interpretation.

Additionally, the user interface manager 114 can authenticate users based on their speech input, comparing received speech against stored voice profiles while considering the determined orientation. This ensures accurate authentication regardless of how the device 102 is worn or positioned and promotes security ensuring authorized users have access to the device 102 and unauthenticated users may be prevented from causing the device 102 to respond to voice commands, or limited commands that do not expose authorized user information secured by the device 102. User authentication based on speech, implemented by the user interface manager 114, may utilize voice recognition technologies similar to those in advanced speech recognition software or voice matching systems. This ensures security across various wearing positions, akin to the continuous authentication features in some modern smartphones.

In operation, the user 104 may provide speech input 106 to the wearable device 102, which is captured by the microphone array 112. The audio input interface 120 processes this input and passes it to the sound based orientator 124, which determines the voice direction 126 to optimize signal-to-noise ratio for the user's voice. Subsequently, the audio output interface 122 may prompt the user 104 through speakers 110 to generate additional sounds at different horizontal positions in sequence. First, the user generates a snap to the left (or right), and the microphone array 112 captures this sound to establish the left-right axis. Then, the user generates a snap to the front, and the microphone array 112 captures this sound to establish the front-back axis. The sound based orientator 124 analyzes the time differences and/or intensity differences between these sequential sounds to establish the horizontal body plane. The up-down axis is then determined using the appropriate hand rule based on the sequence of snaps. By comparing the voice direction 126 with the established up direction, the device can determine whether it is worn on the head or body. This process allows the wearable device 102 to determine its spatial orientation relative to the user 104 without relying on conventional motion sensors, enabling accurate audio processing and user interaction across various wearing scenarios.

By integrating these components and functions, the wearable device 102 accurately determines its orientation relative to the user 104 body using sound inputs. This approach enables enhanced audio processing, 3D sound localization, beamforming, and acoustic sensing across various wearing scenarios without relying on traditional orientation sensors. The techniques for device orientation based on sound have potential to reduce device complexity and cost while maintaining functionality, which is particularly beneficial for creating affordable devices that can be positioned in various orientations on a user's body, clothing, or held in hand.

FIG. 2 depicts a block diagram of a system 200 with audio processing components, in accordance with one or more implementations of device orientation based on sound. The system 200 is described in the context of the environment 100 and is a detailed example of a computing device, such as the wearable device 102, which is operable to implement the described techniques related to device orientation based on sound using similarly labeled elements as FIG. 1. For example, the system 200 represents the wearable device 102 depicted in FIG. 1, a different wearable device, such as smart glasses and computerized watches, a mobile device such as a smartphone, laptop, or tablet, or stationary devices such as smart speakers, speaker assistants, desktops, and servers. The system 200 is implemented using a processing system and a memory system configured to execute instructions to implement the user interface manager 114, the sound calibrator 116, and components thereof. Examples of the memory and processing systems are described in relation to FIG. 8, which depicts device 800 as an example device implementation of the system 200.

The system 200 includes the user interface manager 114, the sound calibrator 116, and the audio system 108. The user interface manager 114 contains the audio input interface 120 and the audio output interface 122.

The audio system 108 includes the speakers 110 and the microphone array 112. The speakers 110 may include one or more of wired speaker 202 and wireless speaker 204. For example, the wireless speaker 204 is operatively coupled to the system 200 via a wireless data connection, such as Bluetooth (TM). The microphone array 112 includes microphones 206 arranged in a configuration labeled as M1, M2, M3, and M4, forming three directional elements and one omnidirectional element of the microphone array 112 aligned along the B-format axes defining the device orientation, e.g., as depicted in FIG. 1.

The audio output interface 122 includes an audio output 208, which is audio information, data, or signals for output using the speakers 110. For example, the audio output 208 represents a prompt generated by the user interface manager 114 to request a new speech input or additional sounds to align the device orientation 128 with the user body.

In this example, the sound calibrator 116 includes multiple components for processing audio signals. These components include the sound based orientator 124, a horizontal plane detector 212, a direction of arrival estimator 214, and a beamformer 216. The sound calibrator 116 interfaces with a sound data 210 storage that contains information about the voice direction 126, the device orientation 128, a horizontal body plane 218, a default beam pattern 220, and a modified beam pattern 222.

The audio input interface 120 processes the speech input 106 captured by the microphone array 112. The audio input interface 120 can analyze differences in arrival time and sound intensity at each microphone of the microphone array 112 to calculate the voice direction 126 of the voice of the user 104. As depicted in FIG. 1, the audio input interface 120 maintains the speech input 106 received by the microphone array 112 and also includes a voice authenticator 224.

The voice authenticator 224 compares received speech input 106, against stored voice profiles to verify identity of the user 104. This authentication capability of the voice authenticator 224 enables the system 200 to selectively apply modified beam patterns for authorized users, enhancing both audio quality and security. The voice authenticator 224 can operate across various device wearing positions and orientations, ensuring consistent authentication regardless of how the system 200 is positioned relative to the user's body.

Regarding the sound calibrator 116, the sound based orientator 124 determines the device orientation 128 without utilizing inertial measurement units. The sound based orientator 124 first processes voice direction 126 data from the audio input interface 120 to optimize signal-to-noise ratio for the user's voice, which may be to one side or the other of the device rather than aligned with any particular axis. For example, the sound based orientator 124 receives the voice direction 126 data as an input signal from the audio input interface 120. This data includes time and intensity differences between the microphone signals, which the sound based orientator 124 uses to calculate the direction toward the user's mouth. The horizontal plane detector 212 then analyzes time differences and/or intensity differences of sequential additional sounds generated by the user 104 at different horizontal positions to establish a horizontal body plane 218. The horizontal plane detector 212, for instance, receives audio signals of the additional sounds from the microphone array 112 via the audio input interface 120, such as a first finger snap from a hand of a side extended arm (defining the left-right axis), and then a second finger snap from a hand of a front-extended arm (defining the front-back axis). The horizontal plane detector 212 then processes these signals to extract timing information and determine the horizontal plane.

The direction of arrival estimator 214 uses the established horizontal body plane 218 to determine the up-down axis using a hand rule. For example, if the first snap was to the left and the second to the front, the left-hand thumb rule is applied: pointing fingers of the left hand to the left and curling them toward the front, with the thumb pointing up. If the snaps were directed to be to the right and then front, the right-hand thumb rule would be used instead. After establishing the B-format axes, the direction of arrival estimator 214 can compare the voice direction 126 to the established up direction to determine whether the device is worn on the head (voice direction pointing down) or on the body (voice direction pointing up). The direction of arrival estimator 214 combines these inputs using spatial audio algorithms to generate a complete 3D orientation model, which is output as a data structure representing the device orientation 128. The beamformer 216 then utilizes the device orientation 128 to modify the beam pattern of the microphone array 112, and individual microphones 206, transitioning from a default beam pattern 220 to a modified beam pattern 222 that better aligns with the source of the speech input encompassing the voice direction 126. For example, the beamformer 216 receives the device orientation 128 data structure as an input and uses the device orientation 128 to calculate new beamforming coefficients to apply to the default beam pattern 220, for reconfiguring the microphones 206 of the microphone array 112 for improved audio capture in the voice direction 126 using the modified beam pattern 222. These coefficients are then applied to the microphone array 112 signals to implement the modified beam pattern 222. The audio input interface 120 may continuously provide updated audio signals to the beamformer 216, allowing for the beamformer 216 to implement real-time adjustments of the modified beam pattern 222 based on changes in orientation or speech source location.

If the sound based orientator 124 detects a possible positional change, the audio output interface 122 can use the speakers 110 to request new speech input from the user for recalibration. This dynamic adaptation ensures accurate orientation determination in various wearing scenarios without relying on accelerometers or gyroscopes.

In operation, the audio input interface 120 may receive speech input 106 through the microphone array 112 and process it to determine voice direction data. This data is then passed to the sound based orientator 124, which analyzes the time and intensity differences between microphone signals to establish the voice direction 126 for optimizing signal-to-noise ratio. The audio output interface 122 may then prompt the user through speakers 110 to generate sequential additional sounds at different horizontal positions. First, the user generates a snap to the left (or right), which defines the left-right axis. Then, the user generates a snap to the front, which defines the front-back axis. The horizontal plane detector 212 captures these sounds via the microphone array 112 and analyzes the time differences and/or intensity differences to establish the horizontal body plane 218. The up-down axis is then determined using the appropriate hand rule based on the sequence of snaps. The direction of arrival estimator 214 then combines this information to construct a complete three-dimensional coordinate system defining the device orientation 128 in space and defined in B-format coordinates. By comparing the voice direction 126 with the established up direction, the device can determine whether it is worn on the head or body. This process allows the system 200 to determine its spatial orientation relative to the user's body without relying on conventional motion sensors, potentially enabling accurate audio processing and user interaction across various wearing scenarios.

The system 200 adapts audio processing based on the determined orientation for various purposes. For example, the beamformer 216 adjusts beamforming to focus on the user's mouth by modifying the default beam pattern 220 to create a modified beam pattern 222 directed towards the voice direction 126. Similarly, the beamformer 216 adjusts beamforming to focus on capturing audio from another person's mouth who is facing the user and communicating from in front of the user 104. In another example, the sound calibrator 116 enhances noise cancellation in specific directions by configuring the microphones 206 of the microphone array 112 to suppress sounds from directions other than the voice direction 126. The audio output interface 122 enhances quality of audio output for the current wearing position by adjusting speaker settings of the speakers 110 based on the device orientation 128. For example, a frequency response, sound pressure level, output volume level, or other speaker setting is adjusted to improve quality of the output. In cases where the speakers 110 are directional speakers, enhancing quality of the audio output can include adjusting the speaker settings to direct the speakers 110 towards the user mouth (e.g., to be consistent with the voice direction 126). This adaptability enables the system 200 to maintain high-quality audio capture and playback across various usage scenarios.

By integrating these components and functions, the system 200 accurately determines its orientation relative to the user's body using sound inputs, and without other sensors. This approach enables enhanced audio processing, 3D sound localization, beamforming, and acoustic sensing across various scenarios without traditional orientation sensors. The system 200 reduces device complexity and cost while maintaining or improving functionality, particularly for devices that can be positioned in various orientations on a user's body, clothing, or held in hand.

FIGS. 3a through 3e illustrates conceptual diagrams 300, 312, 314, 316, and 318 of beam pattern modification and body format relative device orientation based on sound, in accordance with one or more implementations. The diagrams 300, 312, 314, 316, and 318 show spatial relationships between a wearable device 102 and various audio input directions and beam patterns. The diagram 300 shows beam patterns and microphone arrangements. The diagrams 312, 314, 316, and 318 demonstrate user positioning relative the wearable device 102 to align the device orientation to B-format axes 302 relative the user 104.

Illustrated in the diagram 300, the wearable device 102 includes a microphone array comprising a first microphone 206-M1, second microphone 206-M2, third microphone 206-M3, and fourth microphone 206-M4 arranged in a 3D configuration. This arrangement resembles those found in advanced spatial audio recording devices. The microphones are positioned relative to right-left, front-back, and up-down coordinate axes to enable three-dimensional sound detection when the microphones 206 are positioned to define the B-format axes 302. This configuration enables the device to capture audio input from multiple directions simultaneously, allowing precise localization of sound sources in 3D space, with quality and results achievable with professional ambisonic microphones used in immersive audio production.

The diagram 300 shows multiple directional patterns including a voice direction 126 indicating the direction of the speech input 106, a default direction 304 associated with a default beam pattern 220, and a modified direction 306 associated with the modified beam pattern 222, which represent different audio reception configurations. These patterns illustrate how the device can adapt its audio capture focus based on the detected orientation and sound source location, demonstrating capabilities akin to those of adaptive beamforming systems used in high-end teleconferencing equipment.

Next, turning to FIG. 3b, the diagram 312 shows a silhouette of a user 104 with arms extended horizontally with one extended to the right and the other extended to the front, establishing the horizontal body plane 218 at shoulder height. A vertical body axis 310 normal to the horizontal body plane 218 is labeled as the up-down axis. The horizontal body plane 218 encompasses regions around the user 104, including regions in front, behind, or on either side. The vertical body axis 310 establishes a directional vector to use as a frame of reference towards a user mouth or a user head relative to the horizontal body plane 218. The vertical body axis 310 is useful to indicate a right-side up orientation the wearable device 102 that is consistent with a right-side-up orientation corresponding to a top of a user head. For example, if the user 104 is standing, as illustrated in FIG. 3b, the vertical body axis 310 extends from a top of the user head to the user feet. If the user is seated, the vertical body axis 310 extends perpendicular from the top of the user head to the base of the user neck or the horizontal plane 218. If the user 104 is lying down, the vertical body axis 310 is parallel with the horizontal body plane 218 and the directional vector provided by the vertical body axis 310 pointing towards the user mouth or head is adjacent to or slightly elevated above the horizontal body plane 218. The diagram also depicts additional sounds 308, including a first additional sound 308-1 and a second additional sound 308-2 positioned on opposite sides of the user 104 at different lateral positions within the horizontal body plane 218. For example, the additional sounds 308 represent clicking or snapping noises made with a clicker in hand or fingers. The additional sounds 308 may include finger snaps or clicker sounds generated at approximately shoulder height positions from fully extended arms establishing the horizontal body plane 218 including the right-left axis defined by one extended arm held to the side of the user 104 and the front-back axis defined by the other extended arm held in front of the user 104. FIG. 3c shows the diagram 314, which is a top down view of the diagram 312.

This configuration demonstrates how the wearable device 102 utilizes multiple sound inputs to determine its orientation relative to the user's body. The speech input 106, represented by the voice direction 126, is first established to optimize signal-to-noise ratio for the user's voice, which may be to one side or the other of the device rather than aligned with any particular axis. The sound calibrator 116, as described in FIG. 2, processes this input through its sound based orientator 124 to identify the direction toward the user's mouth. This process may employ algorithms similar to those used in voice activity detection and speaker localization systems found in smart home devices.

The additional sounds 308-1 and 308-2 are generated sequentially, not simultaneously, to define the horizontal body plane 218. First, the user generates a snap to the left (or right), which defines the left-right axis. Then, the user generates a snap to the front, which defines the front-back axis. The horizontal plane detector 212 analyzes the time differences and/or intensity differences between these sequential sounds reaching the various microphones in the array. This analysis allows the device 102 to establish the horizontal body plane 218 as a reference for the right-left and front-back plane relative to the user's body. Once these two axes are established, the up-down axis is determined using the left-hand thumb rule: pointing fingers of the left hand to the left and curling them toward the front, with the thumb pointing up. If the snaps were directed to be to the right and then front, the right-hand thumb rule would be used instead. This process is different than room calibration procedures used in advanced home theater systems by leveraging user-generated sequential sounds and a mobile microphone array.

After establishing the B-format axes through the sequential snapping sounds, the direction of arrival estimator 214 can compare the voice direction 126 to the established up direction to determine whether the device is worn on the head (voice direction pointing down) or on the body (voice direction pointing up). This process does not rely on traditional inertial measurement units, instead using purely acoustic inputs to determine the device position and the device orientation 128. This technique creates a comprehensive 3D orientation system that rivals the accuracy of sensor fusion algorithms used in augmented reality headsets but achieved solely through acoustic means.

The beamformer 216 utilizes this comprehensive orientation information to modify the microphone array 112 beam pattern. As illustrated in comparing the diagram 316 depicted in FIG. 3d with the diagram 318 shown in FIG. 3e, this modification transitions the audio capture focus from the default direction 304 to the modified direction 306, which more closely aligns the device orientation with the B-format axes that are in alignment with the user 104. This adaptive beamforming enhances the quality of audio capture by focusing listening capabilities towards the user 104 mouth or in front of the user 104, regardless of how the device 102 is positioned relative to the body of the user 104. The system 200 ability to determine and adapt to various wearing positions improves user satisfaction. For instance, if the wearable device 102 is placed sideways or at an angle on the user's body, the combination of voice input and additional sounds allows the device 102 to recalibrate its orientation without relying on accelerometers or gyroscopes. This flexibility facilitates quality audio performance across a wide range of wearing scenarios.

Moreover, the system 200 can prompt the user 104 for new audio inputs if the system 200 detects a significant change in position. For example, if the user moves the device 102 from their chest to a different body location, the audio output interface 122 may use the speakers 110 to request new speech input and additional sounds. The user interface manager 114, for instance, receives a signal from a clothing attachment feature (e.g., a clip, a magnet, a connector) when the device 102 is worn. When the device 102 is repositioned, the user interface manager 114 senses that signal disappearing and then reappearing when the device 102 is reattached. In response to detecting a signal from the attachment feature of the device 102 after detecting no signal previously, the user interface manager 114 can initiate the recalibration process (e.g., prompt the user 104). This dynamic recalibration process ensures that the device maintains accurate orientation and facilitates quality audio capture regardless of repositioning, analogous to the continuous adaptation mechanisms found in some noise-cancelling headphones.

The horizontal body plane 218 and vertical body axis 310 established through this process serve as reference points for ongoing audio processing. The system 200 can use these references to continually adjust its beam patterns, ensuring that focus is maintained on the user's voice even if the user moves or changes position relative to the device 102.

This sound-based orientation technique also enhances the device's security features. The voice authenticator 224 can use the established orientation to compare incoming speech more accurately against stored voice profiles, ensuring that authorized users can access various device functions or trigger specific audio capture modes. This integration of spatial awareness with biometric security represents an improved approach to user authentication in wearable devices, utilizing advanced voice recognition algorithms similar to those employed in secure voice-controlled login systems.

When the wearable device 102 activates, the microphone array 112 may detect sounds from multiple directions simultaneously. Upon detecting the user 104 speaking a phrase, the sound based orientator 124 may identify the voice direction 126 as a vector pointing towards the user 104. A combination of microphones 206 may be noted as a primary audio capture channel. The audio output interface 122 may then output a response through the speakers 110 and listen for additional sounds to establish a frame of reference between the device 102 and the user 104.

Subsequently, the device prompts the user to generate sequential finger snaps or similar sounds. First, the user 104 generates a snap to the left (or right), and the microphone array 112 captures this sound to establish the left-right axis. Then, the user generates a snap to the front, and the microphone array 112 captures this sound to establish the front-back axis. The audio output interface 122 outputs a confirmation (e.g., audio indicating “I received your snaps”) after each sound is successfully captured. A different combination of microphones 206 may then be directed towards a potential location in front of the user 104 to establish a primary channel for improving capture quality from people talking to the user 104.

These sequential snapping sounds enable the horizontal plane detector 212 to establish the horizontal body plane 218 without using a gyroscope. The up-down axis is then determined using the appropriate hand rule based on the sequence of snaps. The sound based orientator 124 may determine source direction using three microphones 206, assuming the plane is horizontal. To account for scenarios where the wearable device 102 is not worn horizontally, after using sound to define B-format axes, the direction of arrival estimator 214 may map the four microphones 206 to create the horizontal body plane 218. By comparing the voice direction 126 with the established up direction, the device can determine whether it is worn on the head or body.

This approach may allow the device 102 to enhance both audio capture and audio output, potentially improving the quality of user experience from various wearing positions and orientations relative to the user's body. The beamformer 216 may utilize this comprehensive orientation information to modify the microphone array 112 beam pattern, transitioning from the default beam pattern 220 to a modified beam pattern 222 that more closely aligns with the source of the user's voice and potential conversation partners.

The sound calibrator 116 may continuously refine the device orientation 128 based on ongoing audio inputs, allowing for dynamic adjustments as the user 104 moves or repositions the device 102. The user interface manager 114, for instance, receives a signal from a clothing attachment feature (e.g., a clip, a magnet, a connector) when the device 102 is worn. When the device 102 is repositioned, the user interface manager 114 senses that signal disappearing and then reappearing when the device 102 is reattached. In response to detecting a signal from the attachment feature of the device 102 after detecting no signal previously, the user interface manager 114 can initiate the recalibration process of the sound calibrator 116. In variations, the user 104 provides speech input “I've repositioned the device”, which when detected by the user interface manager 114 is used to trigger the sound calibrator 116. In some examples, the device 102 occasionally (e.g., periodically) compares signal properties (e.g., the amplitude and frequency spectrum) of the user's speech and if a change consistent with moving the device 102 to a different position relative the user 104, the device 102 automatically queries the user 104 to ask whether the device 102 is moved. If the user 104 provides an affirmative response, then the sound calibrator 116 is triggered. This adaptive process may enable the wearable device 102 to maintain high quality audio across a wide range of usage scenarios without relying on traditional motion sensors.

By integrating these various components and techniques, the wearable device 102 achieves a sophisticated level of spatial awareness and audio processing capability without additional sensors. This approach reduces the complexity and cost of the device and also enables the device 102 to adapt to a wide range of usage scenarios, from different body-worn positions to handheld use, while maintaining quality audio performance and user interaction capabilities. Overall, the device 102 and the system 200, when described in relation to FIGS. 3a through 3e, demonstrate an efficient and cost-effective compact or wearable formfactor, configured to implement enhanced directional based audio processing without relying on orientation sensors. The techniques enable a level of spatial audio processing and user interaction typically associated with much larger or more specialized equipment.

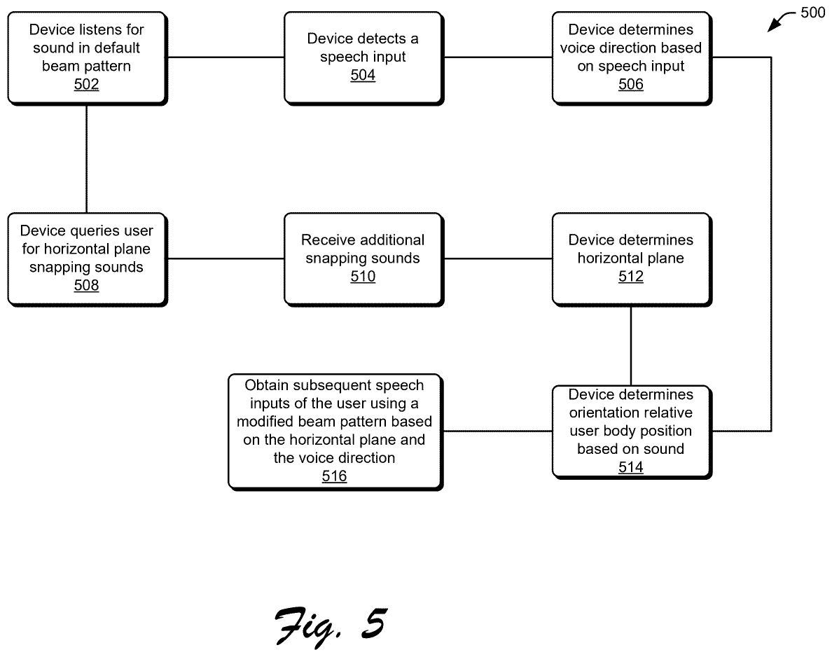

FIG. 4 illustrates a flow chart depicting an example process 400 for device orientation based on sound in accordance with one or more implementations. The process 400 may be performed in the context of the environment 100, such as by the computing device 102 and/or the system 200, utilizing components similar to those found in advanced spatial audio recording devices and smart home assistants.

At step 402, the device 102 listens for sound in a default beam pattern. For example, the step 402 detects speech input of a user from a plurality of microphone pairs of a microphone array that are each oriented about different axes of a device orientation. The microphone array 112 of the wearable device 102 captures the speech input 106 using its multiple microphone pairs (e.g., 206-M1, 206-M2, 206-M3, 206-M4) arranged in B-format axes, similar to the configuration used in professional ambisonic microphones. The audio input interface 120 processes this captured speech input, analyzing the signals from each microphone pair to detect the user's voice, employing techniques akin to those used in high-end voice activity detection systems.

At step 404, the device 102 queries user for speech input. For example, the step 404 determines a voice direction towards a mouth of the user relative to the device orientation based on the speech input 106. The sound based orientator 124 within the sound calibrator 116 analyzes the processed speech input to calculate the voice direction 126. This calculation involves comparing the time and intensity differences of the speech signals captured by different microphone pairs to establish the direction vector pointing towards the user's mouth, which may be to one side or the other of the device rather than aligned with any particular axis, utilizing algorithms implemented by advanced acoustic source localization systems.

At step 406, the device 102 detects speech input. For example, the device 102 detects the speech input 106 for modifying audio input and output settings that improve capture quality and audio output quality in the voice direction 126 of the user 104 when first attached to the user 104, when first powered on or woken up, when detached and reattached or otherwise adjusted positionally relative the user, the device 102 triggers the microphone array 112 to detect speech input. The step 406 may occur once due to high energy expenditure to output audio for requesting and receiving audio for capturing the speech input.

At step 408, whether the beam pattern is directed at the direction of the speech input is determined. For example, if YES at step 408, the device 102 does not change the audio input and output settings and the beam pattern is stored as corresponding to the user 104. However, if NO at step 408, the process 400 automatically proceeds to step 410, where the device 102 modifies a beam pattern in the direction of the speech input.

At step 412, the modified beam pattern is automatically applied to process subsequent speech inputs of the user detected with the microphone array. For example, the device 102 applies the modified beam pattern when detecting subsequent speech inputs of the user 104 with the microphone array 112. When the audio input interface 120 detects new speech input from the same user, the system 200 retrieves the stored modified beam pattern 222 corresponding to that user. The beamformer 216 then applies this improved pattern to the microphone array 112, ensuring continued high-quality audio capture without requiring recalibration for each interaction. This adaptive process is similar to continuous calibration techniques used in some advanced noise-cancelling headphones, however, without the use of sensors other than the microphones.

This process 400 demonstrates how the wearable device 102 can dynamically adapt its audio capture capabilities based on the user's position, enhancing speech recognition accuracy and overall audio quality. By leveraging the spatial audio processing capabilities of the microphone array 112 and the adaptive algorithms implemented in the sound calibrator 116, the device can maintain quality performance across various wearing scenarios and user movements, without relying on traditional orientation sensors.

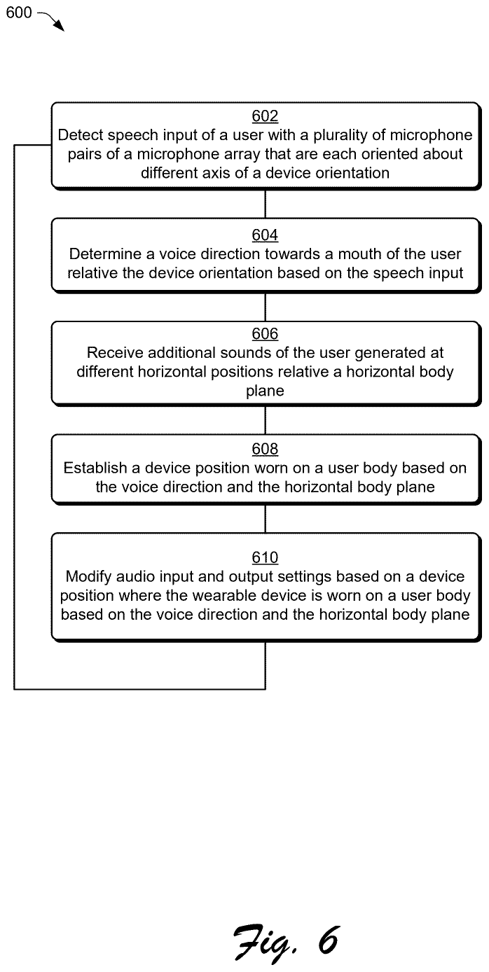

FIG. 5 illustrates a flow chart depicting an example process 500 for device orientation based on sound in accordance with one or more implementations. The process 500 may be performed in the context of the environment 100, such as by the device 102 and/or the system 200.

At step 502, the device listens for sound in default beam pattern. For example, the microphone array 112 captures audio input using its multiple elements, similar to step 402 in process 400. The audio input interface 120 processes this input, employing advanced voice activity detection techniques to isolate potential user speech.

At step 504, the device detects a speech input. For example, the sound based orientator 124 analyzes the speech input 106 to calculate the voice direction 126, establishing a vector that points towards the user's mouth.

At step 506, the device determines voice direction based on the speech input. The sound based orientator 124 for instance analyzes the processed speech input 106 to calculate the voice direction 126, establishing a vector that points towards the user's mouth. This step 506 establishes the voice direction 126, which is primarily to optimize signal-to-noise ratio for the user's voice and may be to one side or the other of the device rather than aligned with any particular axis. The sound based orientator 124 may employ advanced acoustic source localization algorithms to precisely map this direction. This voice direction 126 serves as a reference point for subsequent audio processing adjustments but is not yet used to determine the B-format axes alignment.

At step 508, the device queries user for horizontal plane snapping sounds. This step establishes a reference plane referred to as a horizontal body plane 218, which is similar to but different than techniques used in advanced spatial audio calibration systems. The audio output interface 122, for instance, may prompt the user to generate specific sounds at different horizontal positions. In variations, the device 102 requests a snap from a side lateral position and another snap from a front lateral position (e.g., at shoulder height). In some examples, the device 102 requests a snap from a specific side (e.g., right-side or left-side) and from a specific front or back position. By requesting and obtaining additional sounds from specifically chosen locations relative the user 104, the device 102 is configured to easily determine an up direction along an up-down axes. Since the device 102 controls the order of snaps for deriving each of the two horizontal axes of the horizontal body plane 218, the device 102 infers which way is up, without referring to the speech input or relying on signal from audio received in the direct of the user's mouth. In addition, by incorporating both the two snaps (in directed order) with the vector to the mouth, the device 102 is operable to determine whether the device 102 is above or below the mouth of the user 104. If above the mouth, the device 102 operated in head worn configuration, which may be recorded as useful device status information for controlling features and functions of the device 102.

At step 510, the device receives the additional snapping sounds. The microphone array 112 captures these additional sounds, which may be finger snaps or clicks generated by the user at arm's length on either side of their body, and in front of or behind the body of the user 104. These sounds are generated sequentially, not simultaneously-first a snap to the left (or right), which defines the left-right axis, and then a snap to the front, which defines the front-back axis. This step receives additional sounds of the user generated at different horizontal positions relative to a horizontal body plane to configure the wearable device to have up to a 360 degree frame of reference around the user body, which is normal to the vertical body axis 310.

At step 512, the device determines horizontal plane. The horizontal plane detector 212 analyzes the time delays between the additional sounds reaching different microphones in the array. This analysis allows the system to establish a horizontal body plane 218 relative to the user's body, creating a reference frame for the device orientation 128 based on time differences and/or intensity differences between receipts of the additional sounds.

At step 514, the device determines orientation relative to user body position. The direction of arrival estimator 214 combines the horizontal plane data from step 512 to establish the B-format axes. The up-down axis is determined using the left-hand thumb rule: pointing fingers of the left hand to the left and curling them toward the front, with the thumb pointing up. If the snaps were directed to be to the right and then front, the right-hand thumb rule would be used instead. After establishing the B-format axes, the system can compare the voice direction 126 to the established up direction to determine whether the device is worn on the head (voice direction pointing down) or on the body (voice direction pointing up). This step effectively maps the device's position worn on a user body based on the voice direction and the horizontal body plane, without relying on traditional inertial measurement units.

Following step 514, the device may modify audio input and output settings. The beamformer 216 adjusts the microphone array's beam pattern based on the established device position, improving audio capture for the current wearing configuration. Simultaneously, the audio output interface 122 may adjust speaker settings to enhance audio playback based on the device's position relative to the user's ears. For example, a frequency response, sound pressure level, output volume level, or other speaker setting is adjusted to improve quality of the output. In cases where the speakers 110 are directional speakers, the speaker settings are adjustable to direct the audio output signal towards the user mouth (e.g., the speakers 110 direct the audio output signal in an opposite direction as the voice direction 126).

At step 516, the device may obtain subsequent speech inputs of the user using a modified beam pattern based on the horizontal plane and the vertical direction. For example, the microphone array 112 is steered towards the voice direction 126 by aligning the device orientation with the body frame of reference to improve capture quality of subsequent speech inputs received.

In variations, when the wearable device 102 activates, the microphone array 112 can be utilized at step 502 to detect sounds from multiple directions simultaneously. At step 504, upon detecting the user 104 speaking the phrase “I've clipped on my device,” the sound based orientator 124 can identify at step 506 the voice direction 126 as vector pointing towards the user 104. A combination of microphones 206 can be noted as a primary audio capture channel. Then, at 508, the audio output interface 122 can output “Thanks-I hear you” through the speakers 110 and listen for additional sounds to establish a frame of reference between the device 102 and the user 104. At 510, the user 104 can say “I'm snapping my left hand fingers with my left arm extended from my left side,” and snap their fingers until the audio output interface 122 outputs “I've got your left side finger snaps.” Then the user can say “I'm snapping my left hand fingers with my left arm extended in front of me,” and snap their fingers until the audio output interface 122 acknowledges receipt of the front finger snaps. Although left side and front side finger snaps are described in this example, in other examples, right side finger snaps may be used instead of or in addition to the left side snaps. In variations, back side snaps are captured instead of or in addition to the front side snaps. Also in variations, the device 102 prompts the user 104 by requesting “left side snaps” and after acknowledging receipt of the left side snaps, requesting front side snaps. This different combination of microphones 206 can then be directed towards a potential location in front of the user 104 to establish a primary channel for improving capture quality from people talking to the user 104. The user 104 may perform a snap to one side (e.g., their left or right), followed by a snap to either their front or their back. These two sequential snap sounds (e.g., a side snap received in succession with a front or back snap), when detected enable the horizontal plane detector 212 to establish the horizontal body plane 218 consistent with B-format axes aligned to a body of the user 104, without using a gyroscope. The sound based orientator 124 can determine source direction using three microphones 206, assuming the plane is horizontal. To account for scenarios where the wearable device 102 is not worn horizontally, after using sound to define B-format axes, the direction of arrival estimator 214 can map the four microphones 206 to create the horizontal body plane 218. This approach allows the device to enhance audio capture and audio output, improving quality of a user experience from various wearing positions and orientations relative to the user's body.

This process 500 demonstrates an innovative approach to device orientation and audio enhancement that builds upon the process 400. By incorporating user-generated sounds to establish a horizontal reference plane, the system achieves a more comprehensive understanding of the device orientation 128 and relative position to a body of the user 104. The process 500 enables the device to adapt audio processing capabilities across a wide range of wearing scenarios, enhancing both input and output audio quality without additional sensors.

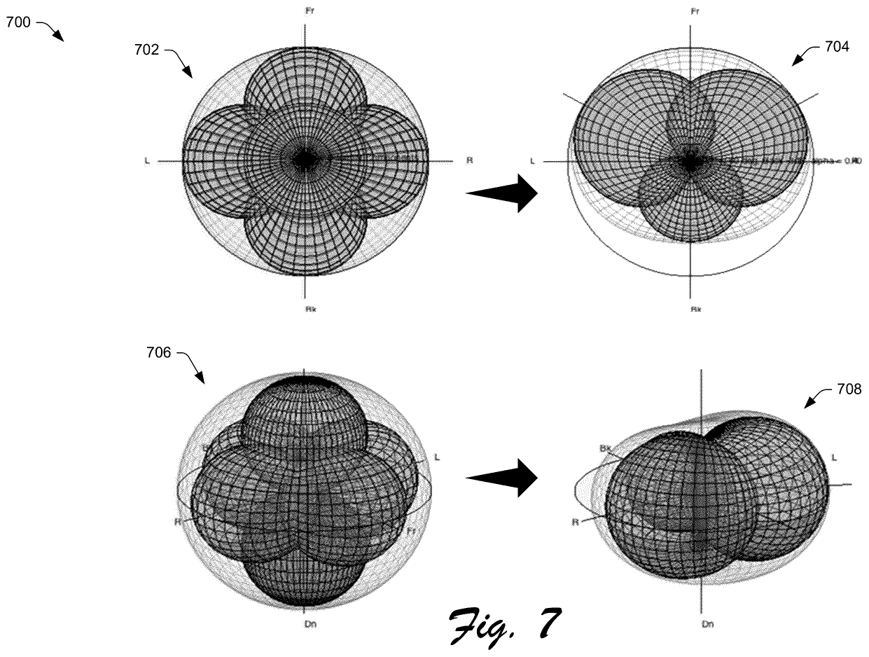

FIG. 6 illustrates a flow chart depicting an example process 600 for device orientation based on sound in accordance with one or more implementations. The process 600 may be performed in the context of the environment 100, such as by the computing device 102 and/or the system 200.

At step 602, the process 600 detects speech input of a user with a plurality of microphone pairs of a microphone array that are each oriented about different axes of a device orientation. The microphone array 112 of the wearable device 102 captures the speech input 106 using its multiple microphones (e.g., 206-M1, 206-M2, 206-M3, 206-M4) arranged in different B-format axes. This configuration enables the device to capture audio input from multiple directions simultaneously. The audio input interface 120 processes this captured speech input, analyzing the signals from each microphone pair to detect the user's voice.

At step 604, the process 600 determines a voice direction towards a mouth of the user relative to the device orientation based on the speech input. The sound based orientator 124 within the sound calibrator 116 analyzes the processed speech input to calculate the voice direction 126. This calculation involves comparing the time and intensity differences of the speech signals captured by the different microphone pairs to establish the direction vector pointing towards the user's mouth. This voice direction 126 is primarily determined to optimize signal-to-noise ratio for the user's voice, which may be to one side or the other of the device rather than aligned with any particular axis.

At step 606, the process 600 receives additional sounds of the user generated at different horizontal positions relative to a horizontal body plane. The microphone array 112 captures these additional sounds, which may be finger snaps or clicks generated sequentially by the user-first at arm's length to the left (or right) side of their body, and then in front of their body. This step establishes a reference plane adapted for a wearable device calibration. The horizontal plane detector 212 processes these sequential sounds to determine the horizontal body plane 218.

At step 608, the process 600 establishes a device position worn on a user body based on the voice direction and the horizontal body plane. The direction of arrival estimator 214 uses the horizontal plane data from step 606 to establish the B-format axes. The left-right axis is defined by the first snap, and the front-back axis is defined by the second snap. The up-down axis is then determined using the left-hand thumb rule: pointing fingers of the left hand to the left and curling them toward the front, with the thumb pointing up. If the snaps were directed to be to the right and then front, the right-hand thumb rule would be used instead. After establishing the B-format axes, the system can compare the voice direction 126 to the established up direction to determine whether the device is worn on the head (voice direction pointing down) or on the body (voice direction pointing up). This step effectively maps the device's orientation relative to the user's body without relying on traditional inertial measurement units.

At step 610, the process 600 modifies audio input and output settings based on a device position where the wearable device is worn on a user body based on the voice direction and the horizontal body plane. The beamformer 216 adjusts the microphone array's beam pattern based on the established device position, transitioning from the default beam pattern 220 to a modified beam pattern 222 that is modified to focus on the user's voice. This adaptive beamforming enhances the quality of audio capture by focusing listening capabilities towards the user's mouth, regardless of how the device 102 is positioned relative to the body of the user 104. Instead of enhancing capture quality of the user speech, the microphone array 112 is adjustable based on the beamformer 216 to improve audio capture from in front of the user 104 (e.g., to obtain audio from someone speaking to the user 104, face-to-face. Simultaneously, the audio output interface 122 may adjust speaker settings of the speakers 110 to enhance audio playback based on the device's position relative to the user's ears. For example, the speaker settings are adjustable to direct the audio output signal generated by the speakers 110 towards the user mouth (e.g., in an opposite direction as the voice direction 126). This adjustment of both input and output settings improves audio performance across a wide range of wearing scenarios, from different body-worn positions to handheld use.

This process 600 demonstrates a sophisticated approach to device orientation and audio enhancement that builds upon the techniques introduced in processes 400 and 500. By combining voice direction detection with sequential user-generated sounds for horizontal plane establishment, the system achieves a robust understanding of its position relative to the user's body. This process 600 enables the device to adapt its audio processing capabilities dynamically, enhancing both input and output audio quality without additional sensors, and potentially improving the accuracy of user authentication through voice recognition in various wearing positions.

The example processes, procedures, algorithms, approaches, and methods described above may be performed in various ways, such as for implementing different aspects of the systems and scenarios described herein. Any services, components, modules, methods, and/or operations described herein can be implemented using software, firmware, hardware (e.g., fixed logic circuitry), manual processing, or any combination thereof. Some operations of the example methods may be described in the context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

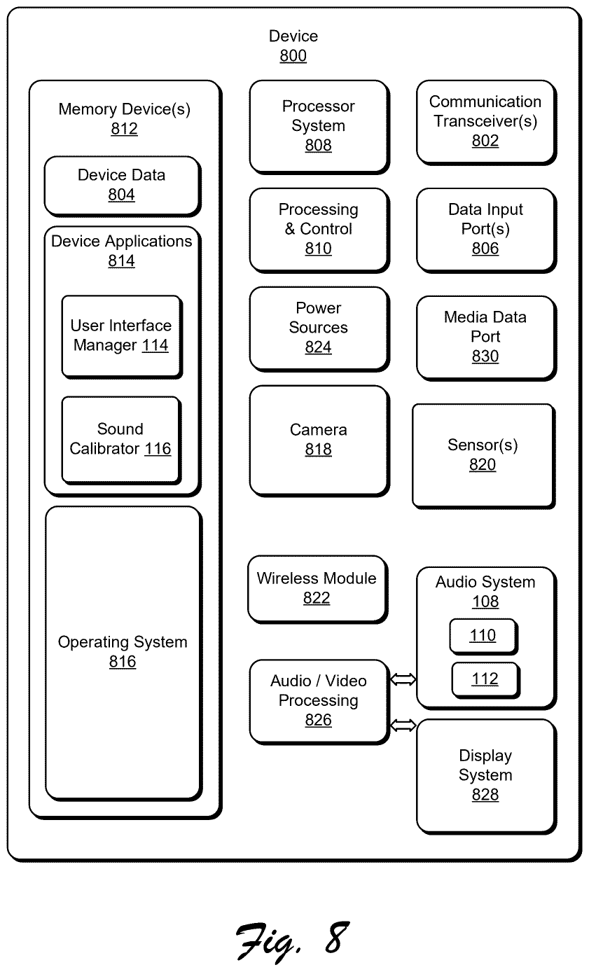

FIG. 7 illustrates multiple perspective views 700 of beam patterns showing the transformation between default and modified beam pattern configurations, in accordance with one or more implementations of device orientation based on sound. The beam patterns shown in the perspective views 700 demonstrate how the device's audio pickup pattern can be adjusted to align with the actual vertical and horizontal orientations relative to the user. View 702 is an initial device orientation of B-format. View 706 is the result of taking the initial device orientation depicted in the view 702, and re-mapping it (e.g., based on the finger snaps, etc.). View 704 is a default stereo pickup configuration of the device 102 based on the initial device orientation and not aimed in a useful manner. View 708 is the result of taking the default stereo pickup configuration depicted in the view 704, and re-mapping it (e.g., based on the finger snaps, etc.) into a useful pattern.

The perspective views 700 demonstrate how the system 200 adapts audio capture patterns based on the established device orientation 128 relative to the user body. When speech input 106 is detected, the audio input interface 120 processes the microphone array 112 signals. The sound calibrator 116 may determine the voice direction 126 and modifies the beam pattern accordingly. The perspective views 700 show how beam pattern configurations can be adjusted from default symmetrical arrangements to modified orientations for different scenarios. This adaptive approach improves audio capture across various wearing positions without relying on inertial measurement unit data, enhancing audio system 108 performance in diverse usage contexts.

FIG. 8 illustrates various components of an example device 800 in which aspects of device orientation based on sound can be implemented in accordance with one or more implementations. The device 800 can be implemented as any of the devices described with reference to the previous FIGS. 1-7, such as any type of mobile device, mobile phone, wearable device, tablet, computing device, communication device, entertainment device, gaming device, media playback device, and/or other type of electronic device. For example, aspects of the wearable device 102 and/or the system 200, as shown and described with reference to FIGS. 1-7 may be implemented as the example device 800.

The device 800 includes communication transceivers 802 that enable wired and/or wireless communication of device data 804 with other devices. The device data 804 can include device identifying data, device location data, wireless connectivity data, and wireless protocol data. Additionally, the device data 804 can include audio, video, and/or image data. The device data 804 can include communication data, such as radio measurements and radio messages. Example communication transceivers 802 include wireless personal area network (WPAN) radios compliant with various IEEE 802.15 (Bluetooth™) standards, wireless local area network (WLAN) radios compliant with any of the various IEEE 802.11 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 800 may also include one or more data input ports 806 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 800 includes a processing system 808 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits 810. The device 800 may further include any type of a system bus or other data and command transfer system that couples the various components within the device. A system bus can include any one or combination of different bus structures and architectures, as well as control and data lines.

The device 800 also includes computer-readable storage memory 812 (e.g., memory devices) that enable data storage, such as data storage devices that can be accessed by a computing device, and that provide persistent storage of data and executable instructions (e.g., software applications, programs, functions, and the like). Examples of the computer-readable storage memory 812 include volatile memory and non-volatile memory, fixed and removable media devices, and any suitable memory device or electronic data storage that maintains data for computing device access. The computer-readable storage memory 812 can include various implementations of random access memory (RAM), read-only memory (ROM), flash memory, and other types of storage media in various memory device configurations. The device 800 may also include a mass storage media device. Computer-readable storage memory 812 represents media and/or devices that enable persistent and/or non-transitory storage of information in contrast to mere signal transmission, carrier waves, or signals per se. Computer-readable storage memory 812 do not include signals per se or transitory signals.

The computer-readable storage memory 812 provides data storage mechanisms to store the device data 804, other types of information and/or data, and various device applications 814 (e.g., software applications). The device applications 814 include the user interface manager 114 and the sound calibrator 116, for instance. As another example of device programs maintained in the computer-readable storage memory 812 include instructions for an operating system 816. The operating system 816, for example, implements aspects of the user interface manager 114 and the sound calibrator 116 to execute communications (e.g., audio calls, video calls, telephone calls, live streams). The instructions can be maintained as software instructions within the memory 812 and executed by the processing system 808. When executed, the instructions cause the processing system 808 to execute the device applications 814, which may also include a device manager, such as any form of a control application, software application, signal-processing and control module, code that is native to a particular device, a hardware abstraction layer for a particular device, and so on.

In this example, the example device 800 also includes a camera 818 and the device sensors 820, including motion sensors, such as may be implemented in an inertial measurement unit (IMU). The motion sensors can be implemented with various sensors, such as the device sensors 820, for example, including a gyroscope, an accelerometer, and/or other types of motion sensors to sense motion of the device. The various motion sensors may also be implemented as components of an inertial measurement unit in the device. The device 800 also includes a wireless module 822, which is representative of functionality to perform various wireless communication tasks, such as through a remote service accessed from a network connection established by the wireless module 822 to a network.

The device 800 can also include one or more power sources 824, such as when the device is implemented as a mobile device. The power sources 824 may include a charging and/or power system, and can be implemented as a flexible strip battery, a rechargeable battery, a charged super-capacitor, and/or any other type of active or passive power source.

The device 800 also includes an audio and/or video processing system 826 that generates audio data for an audio system 108 and/or generates display data for a display system 828. The audio system 108 and/or the display system 828 may include any devices that process, display, and/or otherwise render audio, video, display, and/or image data. For example, the speakers 110 and the microphone array 112 are shown as part of the audio system 108. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 830. In implementations, the audio system and/or the display system are integrated components of the example device. Alternatively, the audio system and/or the display system are external, peripheral components to the example device.

Although implementations of device orientation based on sound have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described, and it is to be appreciated that each described example can be implemented independently or in connection with one or more other described examples. Additional aspects of the techniques, features, and/or methods discussed herein relate to one or more of the following:

In some aspects, the techniques described herein relate to a system including at least one memory, and at least one processor coupled with the at least one memory and configured to cause the system to detect speech input of a user from a plurality of microphone pairs of a microphone array that are non-coplanar, and each oriented about one of three B-format axes of a device orientation, receive additional sounds of the user generated at different horizontal positions relative to a horizontal body plane, determine a voice direction towards a mouth of the user relative to the device orientation based on the speech input by aligning the device orientation to the horizontal body plane, and obtain subsequent speech inputs of the user by modifying a beam pattern of the microphone array based on the voice direction.

In some aspects, the techniques described herein relate to a system, wherein the at least one processor is further configured to cause the system to after aligning the device orientation to the horizontal body plane, determine based on the voice direction relative an up-down axis through the horizontal body plane whether the device is worn on a user head or a user body, and automatically calibrate or adjust audio settings based on whether the device is worn on the user head or the user body.

In some aspects, the techniques described herein relate to a system, wherein the additional sounds of the user include finger snaps or click sounds generated at approximately equidistant positions on a right-left axis and a front-back axis of the horizontal body plane.

In some aspects, the techniques described herein relate to a system, wherein the at least one processor is further configured to define the horizontal body plane based on at least one of time differences or intensity differences between receipts of the additional sounds.

In some aspects, the techniques described herein relate to a system, wherein the at least one processor is further configured to cause the system to align the device orientation to the horizontal body plane by rotating the device orientation into alignment with the horizontal body plane.

In some aspects, the techniques described herein relate to a system, wherein the at least one processor is further configured to cause the system to align the device orientation to the horizontal body plane by rotating a vertical axis of the device orientation into corresponding alignment with a vertical body axis based on the voice direction.

In some aspects, the techniques described herein relate to a method, including detecting, by a wearable device, speech input of a user with a plurality of microphone pairs of a microphone array that are non-coplanar and each oriented about one of three B-format axes of a device orientation, determining, by the wearable device, a voice direction towards a mouth of the user relative to the device orientation based on the speech input, receiving, by the wearable device, additional sounds of the user generated at different horizontal positions relative to a horizontal body plane, establishing, by the wearable device, a device position worn on a user body based on the voice direction and the horizontal body plane, and modifying, by the wearable device, audio input and output settings based on a device position where the wearable device is worn on a user body, the voice direction, and the horizontal body plane.

In some aspects, the techniques described herein relate to a method, wherein modifying the audio input and output settings includes modifying a beam pattern of the microphone array based on the voice direction and the horizontal body plane.

In some aspects, the techniques described herein relate to a method, wherein modifying the audio input and output settings includes modifying speaker settings of the wearable device based on the voice direction and the horizontal body plane.

In some aspects, the techniques described herein relate to a method, wherein the microphone array includes at least three different microphone pairs that are each oriented about one of the three B-format axes of the device orientation.

In some aspects, the techniques described herein relate to a method, wherein determining the voice direction includes receiving the speech input from a first microphone pair of the plurality of microphone pairs that is oriented about an up-down axis, and receiving the additional sounds includes receiving the additional sounds from second and third microphone pairs of the plurality of microphone pairs that are oriented about right-left and front-back orthogonal axes.

In some aspects, the techniques described herein relate to a method, further including authenticating, by the wearable device, the user based on the speech input prior to modifying the audio input and output settings.

In some aspects, the techniques described herein relate to a computing device, including at least one memory, and at least one processor coupled with the at least one memory and configured to cause the computing device to detect speech input of a user from a plurality of microphone pairs of a microphone array that are each oriented about different axes of a device orientation, determine a voice direction towards a mouth of the user relative to the device orientation based on the speech input, modify a beam pattern of the microphone array based on the voice direction that is stored as a modified beam pattern that corresponds to the user, and automatically apply the modified beam pattern based on detecting subsequent speech inputs of the user with the microphone array.

In some aspects, the techniques described herein relate to a computing device, wherein the at least one processor is further configured to cause the computing device to authenticate the user based on the speech input prior to modifying the beam pattern.

In some aspects, the techniques described herein relate to a computing device, wherein the at least one processor is further configured to cause the computing device to authenticate the user based on the subsequent speech inputs prior to automatically applying the modified beam pattern.

In some aspects, the techniques described herein relate to a computing device, wherein the microphone array includes at least three different microphone pairs that are non-coplanar, and each oriented about one of three B-format axes of the device orientation.

In some aspects, the techniques described herein relate to a computing device, wherein the at least one processor is further configured to cause the computing device to determine the voice direction by detecting additional sounds of the user generated at different horizontal positions relative to a horizontal body plane, and determining the voice direction by aligning the device orientation to the horizontal body plane.

In some aspects, the techniques described herein relate to a computing device, wherein the at least one processor is further configured to cause the computing device to detect the additional sounds using two microphone pairs that are each oriented about a different B-format axis of the device orientation.

In some aspects, the techniques described herein relate to a computing device, wherein the at least one processor is further configured to cause the computing device to modify audio output settings of the computing device by aligning the device orientation to the horizontal body plane.

In some aspects, the techniques described herein relate to a computing device, wherein the at least one processor is further configured to cause the computing device to determine based on detecting a change in body position of the computing device relative to the user, prompt the user for a second speech input, determine a second voice direction towards the mouth of the user based on the second speech input, and modify the beam pattern of the microphone array based on the second voice direction that is stored as the modified beam pattern that corresponds to the user.

What is claimed is:

1. A system comprising:
at least one memory; and
at least one processor coupled with the at least one memory and configured to cause the system to:
detect speech input of a user from a plurality of microphone pairs of a microphone array that are non-coplanar, and each oriented about one of three B-format axes of a device orientation;
receive additional sounds of the user generated at different horizontal positions relative to a horizontal body plane;
determine a voice direction towards a mouth of the user relative to the device orientation based on the speech input by aligning the device orientation to the horizontal body plane; and
obtain subsequent speech inputs of the user by modifying a beam pattern of the microphone array based on the voice direction.

2. The system of claim 1, wherein the at least one processor is further configured to cause the system to:
after aligning the device orientation to the horizontal body plane, determine based on the voice direction relative an up-down axis through the horizontal body plane whether the device is worn on a user head or a user body; and
automatically calibrate or adjust audio settings based on whether the device is worn on the user head or the user body.

3. The system of claim 1, wherein the additional sounds of the user comprise finger snaps or click sounds generated at approximately equidistant positions on a right-left axis and a front-back axis of the horizontal body plane.

4. The system of claim 1, wherein the at least one processor is further configured to:
define the horizontal body plane based on at least one of time differences or intensity differences between receipts of the additional sounds.

5. The system of claim 1, wherein the at least one processor is further configured to cause the system to align the device orientation to the horizontal body plane by rotating the device orientation into alignment with the horizontal body plane.

6. The system of claim 5, wherein the at least one processor is further configured to cause the system to align the device orientation to the horizontal body plane by rotating a vertical axis of the device orientation into corresponding alignment with a vertical body axis based on the voice direction.

7. A method, comprising:
detecting, by a wearable device, speech input of a user with a plurality of microphone pairs of a microphone array that are non-coplanar and each oriented about one of three B-format axes of a device orientation;
determining, by the wearable device, a voice direction towards a mouth of the user relative to the device orientation based on the speech input;
receiving, by the wearable device, additional sounds of the user generated at different horizontal positions relative to a horizontal body plane;
establishing, by the wearable device, a device position worn on a user body based on the voice direction and the horizontal body plane; and
modifying, by the wearable device, audio input and output settings based on a device position where the wearable device is worn on a user body, the voice direction, and the horizontal body plane.

8. The method of claim 7, wherein modifying the audio input and output settings includes modifying a beam pattern of the microphone array based on the voice direction and the horizontal body plane.

9. The method of claim 7, wherein modifying the audio input and output settings includes modifying speaker settings of the wearable device based on the voice direction and the horizontal body plane.

10. The method of claim 7, wherein the microphone array includes at least three different microphone pairs that are each oriented about one of the three B-format axes of the device orientation.

11. The method of claim 10, wherein determining the voice direction includes receiving the speech input from a first microphone pair of the plurality of microphone pairs that is oriented about an up-down axis, and receiving the additional sounds includes receiving the additional sounds from second and third microphone pairs of the plurality of microphone pairs that are oriented about right-left and front-back axes.

12. The method of claim 7, further comprising:
authenticating, by the wearable device, the user based on the speech input prior to modifying the audio input and output settings.

13. A computing device, comprising:
at least one memory; and
at least one processor coupled with the at least one memory and configured to cause the computing device to:
detect speech input of a user from a plurality of microphone pairs of a microphone array that are each oriented about different axes of a device orientation;
determine a voice direction towards a mouth of the user relative to the device orientation based on the speech input;
modify a beam pattern of the microphone array based on the voice direction that is stored as a modified beam pattern that corresponds to the user; and
automatically apply the modified beam pattern based on detecting subsequent speech inputs of the user with the microphone array.

14. The computing device of claim 13, wherein the at least one processor is further configured to cause the computing device to:
authenticate the user based on the speech input prior to modifying the beam pattern.

15. The computing device of claim 14, wherein the at least one processor is further configured to cause the computing device to:
authenticate the user based on the subsequent speech inputs prior to automatically applying the modified beam pattern.

16. The computing device of claim 13, wherein the microphone array includes at least three different microphone pairs that are non-coplanar, and each oriented about one of three B-format axes of the device orientation.

17. The computing device of claim 16, wherein the at least one processor is further configured to cause the computing device to determine the voice direction by:
detecting additional sounds of the user generated at different horizontal positions relative to a horizontal body plane; and
determining the voice direction by aligning the device orientation to the horizontal body plane.

18. The computing device of claim 17, wherein the at least one processor is further configured to cause the computing device to detect the additional sounds using two microphone pairs that are each oriented about a different B-format axis of the device orientation.

19. The computing device of claim 17, wherein the at least one processor is further configured to cause the computing device to modify audio output settings of the computing device by aligning the device orientation to the horizontal body plane.

20. The computing device of claim 13, wherein the at least one processor is further configured to cause the computing device to:
determine based on detecting a change in body position of the computing device relative to the user;
prompt the user for a second speech input;
determine a second voice direction towards the mouth of the user based on the second speech input; and
modify the beam pattern of the microphone array based on the second voice direction that is stored as the modified beam pattern that corresponds to the user.
